(19) United States
(12) Patent Application Publication
(10) Pub. No.: US 2004/0038705 A1
(43) Pub. Date: Feb. 26, 2004

(54) Portable terminal equipment and method for previewing e-mail

(75) Inventor: Hideyuki Katayama, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/645,058

(22) Filed: Aug. 21, 2003

(30) Foreign Application Priority Data
Aug. 26, 2002 (JP) 244808/2002

(51) Int. Cl. H04B 7/15

(52) U.S. Cl. 455/550.1; 455/11.1; 455/566; 455/412.1

(57) ABSTRACT

A character string inputted by input means is previewed on display means by replacing each character in the character string by one or a plurality of dots. In addition, characters of a predetermined part of e-mail displayed on terminal display means of terminal equipment to which the e-mail is sent are displayed on the display means.

### BACKGROUND OF THE INVENTION

1. Field of the Invention

The present invention relates to portable terminal equipment and a method for previewing e-mail. More specifically, the present invention relates to portable terminal equipment which previews a character string of e-mail and a method for previewing e-mail.

2. Description of the Related Prior Art

In recent years, portable terminal equipment having an e-mail function such as a cellular phone, the PHS (Personal Handy-phone System) or PDA (Personal Digital Assistant) has been widely used.

When creating e-mail by such portable terminal equipment, the user of the portable terminal equipment may insert a space or carriage return and line feed to arrange the format of the text of the e-mail, thereby readably displaying the e-mail on the screen of terminal equipment to which the e-mail is sent.

When the side to which e-mail is sent is portable terminal equipment such as a cellular phone, the PHS or PDA, on their screen is displayed the text of the e-mail in a format equal to that checked by the user on the screen of portable terminal equipment on the sending side.

When terminal equipment to which e-mail is sent is a PC (Personal Computer), the PC (Personal Computer) has a large amount of receivable data and has a screen larger than that of portable terminal equipment so that the number of characters displayed for one line of the screen of the PC is different from that of the portable terminal equipment. The text of e-mail in a format equal to that checked by the user on the screen of the portable terminal equipment is not always displayed on the screen of the PC.

When the user arranges the format of the text of e-mail on the screen of portable terminal equipment, it may be displayed as a hard-to-understand text on the screen of a PC to which the e-mail is sent.

### SUMMARY OF THE INVENTION

The first portable terminal equipment according to the present invention that has input means inputting a character and display means and has functions of creating, displaying and sending/receiving e-mail, has preview control means that previews a character string by replacing each character in the character string with one or a plurality of dots.

The second portable terminal equipment according to the present invention that has input means inputting a character and display means and has functions of creating, displaying and sending/receiving e-mail, has display processing means that displays characters of a predetermined part of the e-mail displayed on terminal equipment to which the e-mail is sent.

A method for previewing e-mail in portable terminal equipment according to the present invention has the steps of: replacing each character in a character string of the inputted e-mail with one or a plurality of dots; and previewing the character string in which the each character is replaced with the dot or dots.

### BRIEF DESCRIPTION OF THE DRAWINGS

The objects, features and advantages of the present invention will become apparent from the following detailed description when taken with the accompanying drawings in which:

FIG. 1 is a block diagram showing a first embodiment of portable terminal equipment according to the present invention;

FIG. 2 is a flowchart showing an example of the operation of a function of setting the number of characters of a cellular phone according to the first embodiment;

FIG. 3 is a flowchart showing an example of the operation of a preview function of the cellular phone according to the first embodiment;

FIGS. 4(a) and 4(b) are a diagram showing an example of preview of the cellular phone according to the first embodiment;

FIG. 5 is a flowchart showing an example of the operation of a carriage return and line feed position setting function of a cellular phone according to a second embodiment;

FIG. 6 is a flowchart showing an example of the operation of partial display of the cellular phone according to the second embodiment; and

FIGS. 7(a) to 7(c) are a diagram showing an example of partial display of the cellular phone according to the second embodiment.

### DETAILED DESCRIPTION OF THE PREFERRED EMBODIMENTS

A first embodiment according to the present invention will be described.

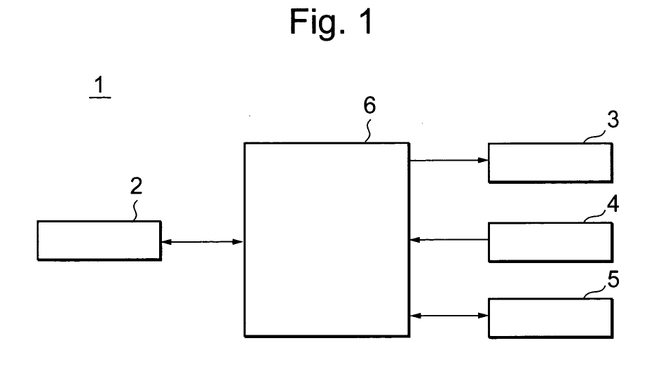

FIG. 1 is a block diagram showing a first embodiment of portable terminal equipment according to the present invention. In this embodiment, the portable terminal equipment will be described by taking a cellular phone as an example. The portable terminal equipment is not limited to the cellular phone and can be applied to various kinds of portable terminal equipment having an e-mail function such as the PHS (Personal Handy-phone System) or PDA (Personal Digital Assistant).

In FIG. 1, a cellular phone 1 has a wireless part 2, a display part 3, an operation part 4, a storage part 5, and a control part 6.

The wireless part 2 modulates and demodulates various radio signals transmitted/received to/from a base station via an antenna, not shown.

The display part 3 consists of a display unit such as a liquid crystal display or organic EL (Electro Luminescence) and displays various menus for selecting various functions and operation of the cellular phone 1 and the contents of e-mail (the text of the e-mail, preview of the e-mail, and partial display displaying a part of the e-mail) so as to realize a function as display means.

The operation part 4 has a device detecting operation input or character input of the user of the cellular phone 1 such as a key, a pointing device or a jog shuttle and sends out detected operation input or character input of the user to the control part 6 so as to realize a function as input means.

The storage part 5 stores setting of a program for realizing various functions such as a communication function and an e-mail function of the cellular phone land data necessary for executing various functions.

The control part 6 cooperates a hardware resource and a software resource so as to realize various functions of the cellular phone 1 such as a communication function, an e-mail function and a preview function. In addition, the control part 6 converts each character of e-mail to a dot or dots for display, that is, to a form other than a character so as to realize a function as preview control means. Further, the control part 6 sets the number of characters per line at preview so as to realize a function as first setting means.

Here, the character refers to a one-byte character.

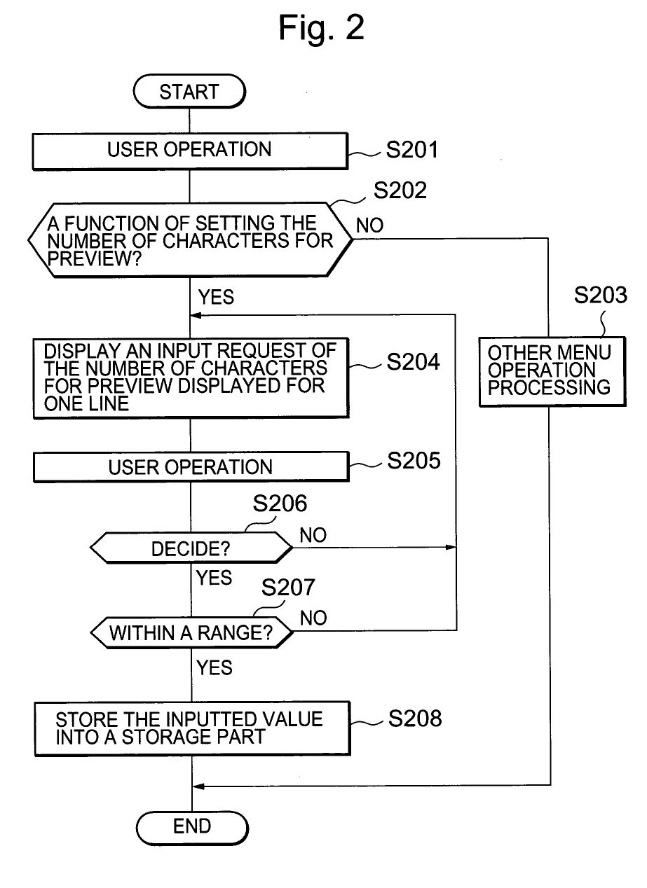

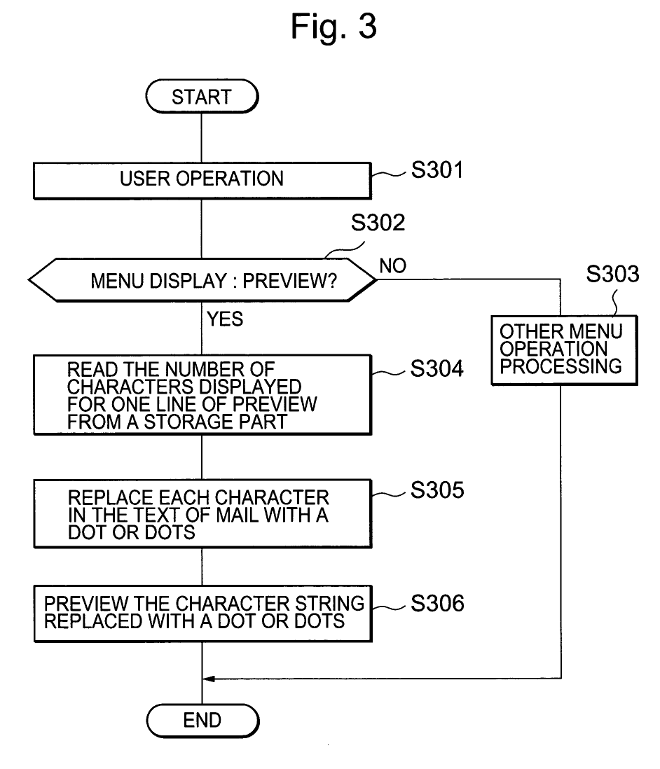

The operation of the cellular phone 1 of this embodiment will be described in detail with reference to FIGS. 2 and 3.

FIG. 2 is a flowchart showing an example of the operation of a function of setting the number of characters of the cellular phone 1 according to this embodiment.

FIG. 3 is a flowchart showing an example of the operation of a preview function of the cellular phone 1 according to this embodiment.

Referring to FIG. 2, the operation of the function of setting the number of characters of the cellular phone 1 according to this embodiment will be described.

In step 201, the operation part 4 detects operation input of the user to continue to step 202.

In step 202, the control part 6 decides whether the operation input detected in step 201 is operation input in which the user selects the function of setting the number of characters from various menu-displayed functions. When the operation input is operation input in which the user selects a function other than the function of setting the number of characters, step 203 is executed. When the operation input is operation input in which the user selects the function of setting the number of characters, step 204 is executed.

In step 203, the cellular phone 1 performs processing of the function selected by the user for termination.

In step 204, the control part 6 displays, on the display part 3, display to prompt for setting the number of characters displayed for one line used when previewing e-mail created by the cellular phone 1. At this time, like “10 to 200 characters”, the range of the number of characters displayed for one line at preview may be displayed. The user can refer to the range of “10 to 200 characters” to select and set the number of characters displayed for one line.

In step 205, the operation part 4 detects operation input performed by the user based on the instruction displayed on the display part 3 in step 204 to continue to step 206.

In step 206, the control part 6 decides whether the operation input of the user is decided. When the operation input is not decided, the routine returns to and executes step 204. When the operation input is decided, step 207 is executed.

In step 207, the control part 6 checks whether a value inputted from the operation part 4 by the user is within the range of a predetermined number of characters, e.g., within three digits. When the inputted value is not within the predetermined range, the routine returns to and executes step 204. When the inputted value is within the predetermined range, step 208 is executed.

In step 208, the control part 6 stores, into the storage part 5, the value inputted in step 207 as a set value specifying the number of characters displayed for one line used when previewing e-mail and terminates the operation of the function of setting the number of characters.

The cellular phone 1 according to this embodiment can suitably and freely set the number of characters per line displayed on the display part 3 at preview.

Referring to FIG. 3, the operation of the preview function of the cellular phone 1 according to this embodiment will be described.

In step 301, the operation part 4 detects operation input of the user to continue to step 302.

In step 302, the control part 6 decides whether the operation input detected in step 301 is operation input in which the user selects the preview function from various menu-displayed functions. When the operation input is operation input in which the user selects a function other than the preview function, step 303 is executed. When the operation input is operation input in which the user selects the preview function, step 304 is executed.

In step 303, the cellular phone 1 performs processing of the function selected by the user for termination.

In step 304, the control part 6 reads the set value stored into the storage part 5, that is, the set value specifying the number of characters displayed for one line to continue to step 305.

In step 305, the control part 6 replaces each character in a character string of e-mail during editing with one or a plurality of dots (for example, two to ten dots. The number of dots is not limited to this and maybe suitably set by the cellular phone 1.) based on the set value read in step 304. More specifically, the control part 6 fetches one character at a time from the beginning of the text of the e-mail during editing, and then replaces each of the fetched characters with a plurality of dots formed in a cluster or one dot, that is, converts it to dot display. The plurality of dots formed in a cluster may be a combination of dots in which a plurality of dots are arrayed in horizontal, vertical and diagonal directions or may be arrayed in a circular or elliptical shape. When the number of characters of the character string of the e-mail is larger than the set value, the control part 6 converts the characters of the number of characters shown by the set value to dot display for performing carriage return and line feed, and subsequently converts each character of the remaining character string to dot display. When a carriage return and line feed code is inserted into the character string before the number of characters converted to dot display reaches the set value, the control part 6 converts the characters before the carriage return and line feed code to dot display for performing carriage return and line feed, and subsequently converts each character of the remaining character string to dot display.

Each character in the text of the e-mail is dot displayed to a plurality of dots formed in a cluster or one dot. The plurality of dot-displayed dots in a cluster are arrayed. Alternatively, the dot-displayed one dot is arrayed.

In step 306, the control part 6 previews, on the display part 3, the character string of thee-mail in which each character is replaced with a dot or dots in step 305, and terminates the operation of the preview function.

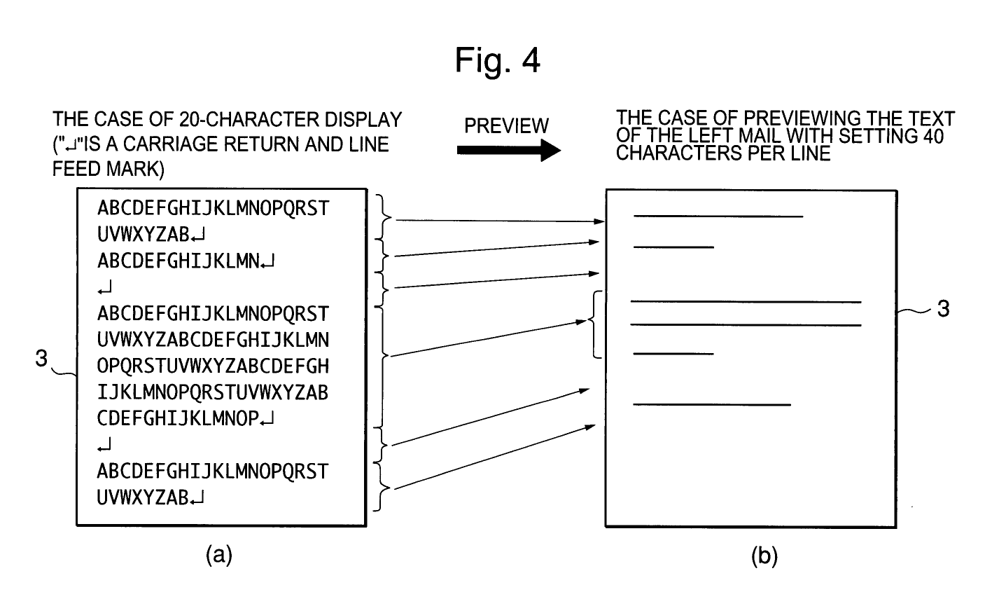

An example of preview displayed on the display part 3 in step 306 is shown in FIG. 4.

FIG. 4 is a diagram showing an example of preview of the cellular phone 1 according to this embodiment.

The display part 3 shown in FIG. 4(a) can display 20 characters for one line. An example in which the text shown in FIG. 4(a) is previewed on the display part 3 with a set value of 40 is FIG. 4(b). In FIG. 4(b), the characters are replaced with a combination of dots in which two dots are arrayed in the horizontal direction. A carriage return and line feed code is inserted every one sentence in the text of the e-mail shown in FIG. 4(a) to mix one sentence exceeding 40 characters and one sentence not exceeding them. As shown in FIG. 4(b), one sentence exceeding 40 characters is dot displayed continuously over two lines or more. One sentence not exceeding 40 characters is dot displayed on one line at a length according to the number of characters. In the text of the e-mail shown in FIG. 4(a), there are lines in which only a carriage return and line feed code exists. As shown in FIG. 4(b), the lines are displayed as a line in which no dot display exists.

The cellular phone 1 of this embodiment previews a character string forming the text of e-mail during editing in a format displayed on a screen functioning as terminal display means of terminal equipment to which the e-mail is sent. The user of the cellular phone 1 finds how the text of the e-mail is displayed on the screen of the terminal equipment to which the e-mail is sent and can check the format of this display.

The cellular phone 1 according to this embodiment specifies, to the set value, the number of characters which can be displayed for one line on the screen of terminal equipment to which e-mail is sent, and inserts a space or carriage return and line feed into the text of the e-mail for preview. While checking the state displayed on the screen of the terminal equipment to which the e-mail is sent, the user can arrange the format of the text of the e-mail.

A second embodiment according to the present invention will be described.

FIG. 1 is a block diagram showing a second embodiment of portable terminal equipment according to the present invention.

FIG. 1 is the same as the block diagram showing the first embodiment of the portable terminal equipment according to the present invention.

The cellular phone 1 according to the second embodiment inserts a carriage return and line feed into the position of a predetermined number of characters of the text of e-mail, and in order that the user can check how the text of the e-mail is displayed on the screen of terminal equipment to which the e-mail is sent, displays, on the display part 3, a part (a predetermined part) of the text displayed on the screen of the terminal equipment.

In the second embodiment, components equal to those of the first embodiment are indicated by the same reference numerals and names and the description is omitted.

The control part 6 realizes partial display which displays, on the display part 3, a part displayed on the screen of the terminal equipment to which e-mail is sent, (for example, a part from the beginning of the sentences between predetermined lines to a predetermined number of characters), of the text of the e-mail during editing so as to realize a function of display processing means.

In addition, the control part 6 inserts a carriage return and line feed code into the position of a predetermined number of characters of a character string of e-mail so as to realize a function as insertion means.

Further, the control part 6 sets a predetermined number of characters indicating the position into which a carriage return and line feed code is inserted so as to realize a function as second setting means.

Here, the character refers to a one-byte character.

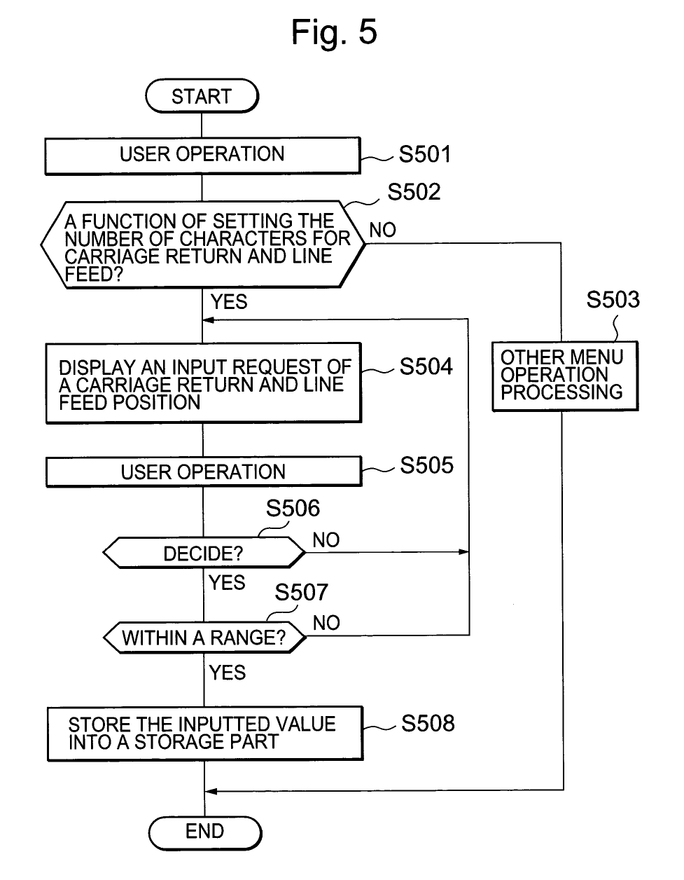

The operation of the cellular phone 1 of this embodiment will be described in detail with reference to FIGS. 5, 6 and 7.

FIG. 5 is a flowchart showing an example of the operation of a function of setting the number of characters for carriage return and line feed of the cellular phone 1 according to this embodiment.

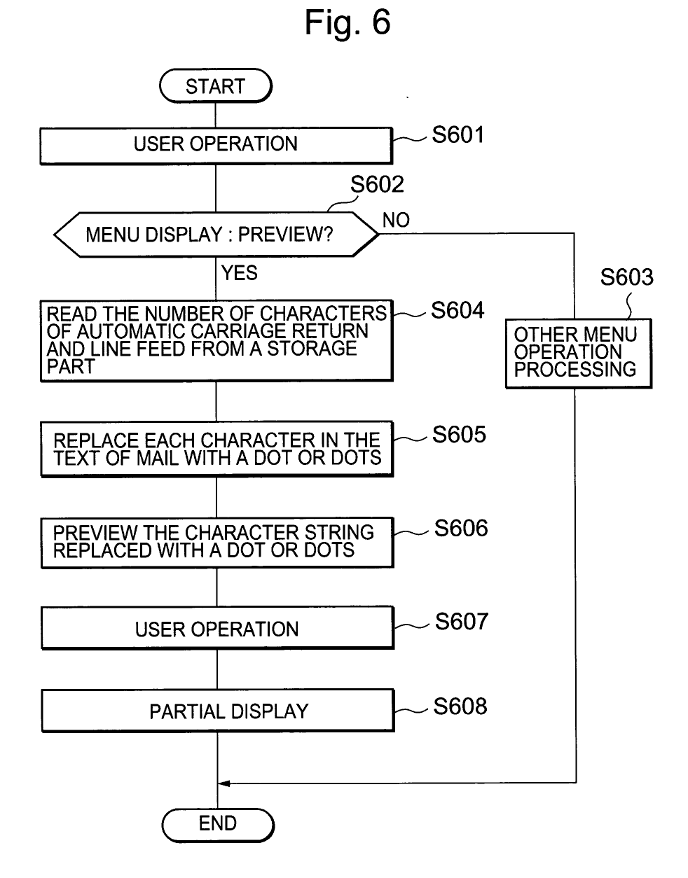

FIG. 6 is a flowchart showing an example of the operation of partial display of the cellular phone 1 according to this embodiment.

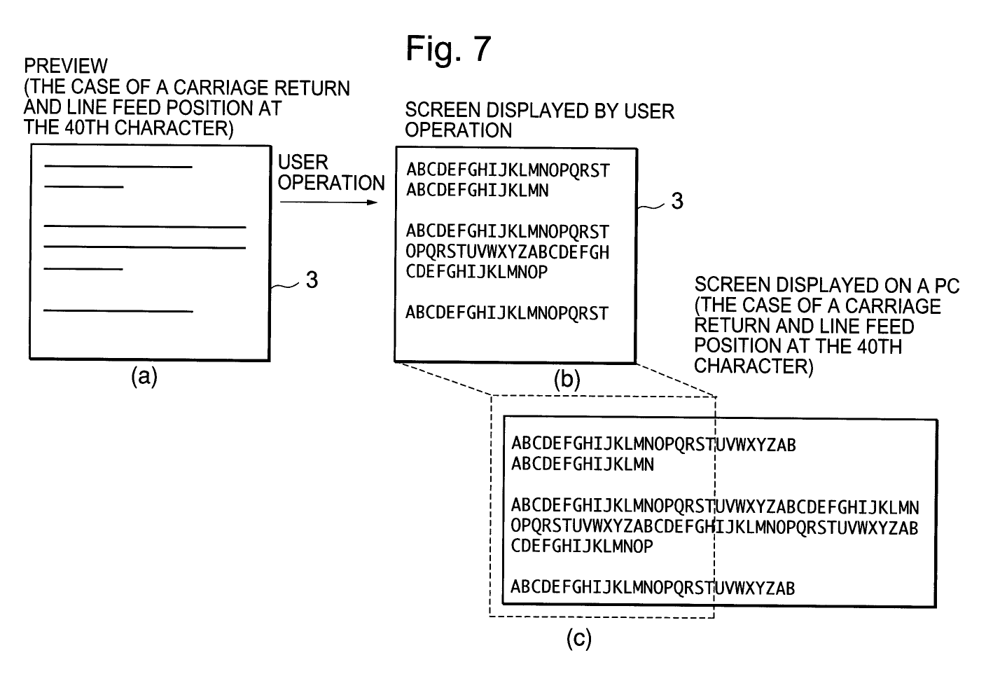

FIG. 7 is a diagram showing an example of partial display of the cellular phone 1 according to this embodiment.

Referring to FIG. 5, the operation of the function of setting the number of characters for carriage return and line feed of the cellular phone 1 according to this embodiment will be described.

In step 501, the operation part 4 detects operation input of the user to continue to step 502.

In step 502, the control part 6 decides whether the operation input detected in step 501 is operation input in which the user selects the function of setting the number of characters for carriage return and line feed from various menu-displayed functions. When the operation input is operation input in which the user selects a function other than the function of setting the number of characters for carriage return and line feed, step 503 is executed. When the operation input is operation input in which the user selects the function of setting the number of characters for carriage return and line feed, step 504 is executed.

In step 503, the cellular phone 1 performs processing of the function selected by the user for termination.

In step 504, the control part 6 displays, on the display part 3, display to prompt for setting specification in what position of the text of e-mail edited by the cellular phone 1 a carriage return and line feed code is inserted. At this time, like “the 10th to 200th characters”, the range of the number of characters indicating the insertion position of the carriage return and line feed code counted from the beginning of a sentence may be displayed. The user can refer to the range of “the 10th to 200th characters” to select and set the position into which the carriage return and line feed code is inserted.

In step 505, the operation part 4 detects operation input performed by the user based on the instruction displayed on the display part 3 in step 504 to continue to step 506.

In step 506, the control part 6 decides whether the operation input of the user is decided. When the operation input is not decided, the routine returns to and executes step 504. When the operation input is decided, step 507 is executed.

In step 507, the control part 6 checks whether a value inputted from the operation part 4 by the user is within the range of a predetermined number of characters, e.g., within three digits. When the inputted value is not within the predetermined range, the routine returns to and executes step 504. When the inputted value is within the predetermined range, step 508 is executed.

In step 508, the control part 6 stores, into the storage part 5, the value inputted in step 507 as a carriage return and line feed value and terminates the operation of the function of setting the number of characters for carriage return and line feed.

The cellular phone 1 according to this embodiment can suitably and freely set the position in which a carriage return and line feed code is inserted into the text of e-mail during editing. The format of a character string forming the text of the e-mail can be arranged into a format desired by the user.

Referring to FIG. 6, the operation of partial display of the cellular phone 1 according to this embodiment will be described.

In step 601, the operation part 4 detects operation input of the user to continue to step 602.

In step 602, the control part 6 decides whether the operation input detected in step 601 is operation input in which the user selects the preview function from various menu-displayed functions. When the operation input is operation input in which the user selects a function other than the preview function, step 603 is executed. When the operation input is operation input in which the user selects the preview function, step 604 is executed.

In step 603, the cellular phone 1 performs processing of the function selected by the user for termination.

In step 604, the control part 6 reads the carriage return and line feed value stored into the storage part 5, that is, the carriage return and line feed value indicating the insertion position of a carriage return and line feed code inserted into the text of the e-mail to continue to step 605.

In step 605, the control part 6 inserts a carriage return and line feed code into the character string of the e-mail during editing based on the carriage return and line feed value read in step 604. The control part 6 then replaces each character in the character string of the e-mail with one or a plurality of dots. More specifically, the control part 6 fetches one character at a time from the beginning of the text of the e-mail during editing into which the carriage return and line feed code is inserted, and then replaces each of the fetched characters with a plurality of dots formed in a cluster or one dot, that is, converts it to dot display. The plurality of dots formed in a cluster may be a combination of dots in which a plurality of dots are arrayed in horizontal, vertical and diagonal directions or may be arrayed in a circular or elliptical shape. The control part 6 converts the characters before the carriage return and line feed code to dot display for carriage return and line feed, and subsequently converts each character of the remaining character string to dot display.

Each character in the text of the e-mail is dot displayed to a plurality of dots formed in a cluster or one dot. The plurality of dot-displayed dots in a cluster are arrayed. Alternatively, the dot-displayed one dot is arrayed.

In step 606, the control part 6 previews, on the display part 3, the character string of thee-mail in which each character is replaced with a dot or dots in step 605.

In step 607, after preview in step 606, the operation part 4 detects operation input of the user to continue to step 608.

In step 608, when the operation input detected in step 607 is operation input requesting partial display, the control part 6 displays, on the display part 3, a predetermined part (for example, 20 characters at the beginning of a sentence of the text of the e-mail) displayed on the screen of terminal equipment to which the e-mail is sent.

An example of partial display displayed on the display part 3 is shown in FIG. 7.

The display part 3 shown in FIG. 7(a) previews the case that a carriage return and line feed code is inserted into the 40th character of the text of the e-mail displayed on the display part 3 shown in FIG. 4(a). The entire format of the text of the e-mail can be checked by preview shown in FIG. 7(a).

The character at the beginning or the end of a sentence cannot be checked in the preview. Some texts may be understood in meaning different from that intended by the writer (user) of the e-mail when a carriage return and line feed position is changed.

The screen of terminal equipment such as a PC to which e-mail is sent is generally larger than the display part 3 and has the maximum number of characters displayed larger than that of the display part 3. It is difficult to display, on the display part 3, e-mail displayed on the screen of the terminal equipment such as a PC by the same format and the character size the user can read.

The cellular phone 1 of this embodiment displays partial display on the display part 3 as shown in FIG. 7(b) when operation input detected by the operation part 4 is operation input requesting partial display by the user. As shown in FIG. 7(c), the text in which carriage return and line feed is performed every 40 characters for one line is displayed on the screen of the terminal equipment such as a PC to which e-mail is sent. FIG. 7(b) shows display of a part from the beginning of a sentence to the 20th character of each line from the beginning line to the eighth line of the text.

The cellular phone 1 according to this embodiment can display a predetermined part of the text of e-mail such as the beginning part of a sentence of each line of the text of the e-mail in which carriage return and line feed is performed in a predetermined position. The user can check the arbitrary m line and n character according to the display ability of the display part 3 of the cellular phone of text display in a predetermined format displayed on the screen of terminal equipment to which the e-mail is sent. The user can check the format of the text of e-mail displayed on the screen of the terminal equipment to which the e-mail is sent and can arrange the format of the text as intended.

The cellular phone 1 according to this embodiment partially displays, on the display part 3, a part from the beginning of a sentence to the 20th character of each line from the first to eighth lines of the text of the e-mail. In the cellular phone 1, the part of the partially displayed text is not limited to the part from the beginning of a sentence to the 20th character of each line from the first to eighth lines and can be suitably and freely set within the range of the number of lines displayed on the display part 3 and the number of characters displayed for one line.

In addition, the cellular phone 1 according to this embodiment partially displays the beginning of a sentence of each line of the text of e-mail. The partially-displayed location is not limited to the beginning of a sentence and can be suitably and freely set at the end of or in the sentence. In this case, the cellular phone 1 can display, on the display part 3, the partially-displayed location by scrolling according to operation of the operation part 4 of the user.

The cellular phone 1 according to this embodiment may perform partial display without inserting any carriage return and line feed code into a predetermined position of the text of e-mail.

The cellular phone 1 according to the first and second embodiments of the present invention handles e-mail during editing and may also handle e-mail after editing.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. Portable terminal equipment that has input means inputting a character and display means and has functions of creating, displaying and sending/receiving e-mail, comprising:
preview control means that previews a character string by replacing each character in the character string with one or a plurality of dots.

2. The portable terminal equipment according to claim 1, wherein said preview control means previews said character string in a predetermined format.

3. The portable terminal equipment according to claim 2, wherein said e-mail is displayed in the format on terminal equipment to which said e-mail is sent.

4. The portable terminal equipment according to claim 1, wherein said plurality of dots are formed in a cluster.

5. The portable terminal equipment according to claim 1, further comprising first setting means setting the number of characters per line; and
wherein said preview control means previews said character string according to setting set by said first setting means.

6. The portable terminal equipment according to claim 1, further comprising insertion means inserting, when the character inputted by said input means exceeds a predetermined number of characters, a carriage return and line feed code before the character exceeding the predetermined number of characters; and wherein said preview control means previews said character string inputted by said input means according to said carriage return and line feed code.

7. The portable terminal equipment according to claim 6, further comprising second setting means setting said predetermined number of characters.

8. The portable terminal equipment according to claim 1, further comprising display processing means displaying a predetermined part of said previewed e-mail in the original character form.

9. The portable terminal equipment according to claim 8, wherein said predetermined part is a part including the left end of said previewed e-mail.

10. Portable terminal equipment that has input means inputting a character and display means and has functions of creating, displaying and sending/receiving e-mail, comprising:
display processing means that displays characters of a predetermined part of said e-mail displayed on terminal equipment to which said e-mail is sent.

11. The portable terminal equipment according to claim 10, wherein said predetermined part includes the beginning part of a line of said e-mail displayed on said terminal equipment.

12. A method for previewing e-mail in portable terminal equipment, comprising the steps of:
replacing each character in a character string of said inputted e-mail with one or a plurality of dots; and
previewing said character string in which said each character is replaced with the dot or dots.

13. The method for previewing e-mail according to claim 12, further comprising a step of selecting a preview function.

14. The method for previewing e-mail according to claim 12, wherein said step of replacing each character in said character string with a dot or dots replaces said each character of said character string in a predetermined format with a dot or dots.

15. The method for previewing e-mail according to claim 14, wherein said e-mail is displayed in the format on terminal equipment to which said e-mail is sent.

16. The method for previewing e-mail according to claim 12, wherein said plurality of dots are formed in a cluster.

17. The method for previewing e-mail according to claim 12, wherein said each character in said character string is replaced with a dot or dots by starting a new line according to a predetermined number of characters per line.

18. The method for previewing e-mail according to claim 12, wherein when the character string of said inputted e-mail exceeds a predetermined number of characters, a carriage return and line feed code is inserted before a character exceeding the number of characters and said each character in said character string is replaced with a dot or dots according to the carriage return and line feed code.
